(19) United States
(12) Patent Application Publication
(10) Pub. No.: US 2003/0069822 A1
(43) Pub. Date: Apr. 10, 2003

(54) Corporate value evaluation system

(75) Inventors: Kunio Ito, Kunitachi-shi (JP); Satohiko Tsukamoto, Chiyoda-ku (JP)

Correspondence Address: BURR & BROWN, PO BOX 7068, SYRACUSE, NY, 13261-7068, US

(73) Assignee: Kunio ITO, Tokyo (JP)

(21) Appl. No.: 10/266,475

(22) Filed: Oct. 8, 2002

(30) Foreign Application Priority Data
Oct. 9, 2001 (JP) 2001-311712
Feb. 7, 2002 (JP) 2002-031002

(51) Int. Cl. G06F 17/60

(52) U.S. Cl. 705/36

(57) ABSTRACT

A brand value evaluation model is proposed which shows the value of a corporate brand as a monetary value, thus providing a scheme capable of appropriately evaluating investment in branding activities. The brand value evaluation model evaluates the economic effect produced by the strength/depth/breadth of the brand image in the minds of stakeholders such as customers, employees and stockholders along three axes of premium, recognition and loyalty, and expresses the brand's power to generate future cash flow with one comprehensive evaluation score (i.e., a corporate brand score).

### BACKGROUND OF THE INVENTION

1. Field of the Invention

The present invention relates to a technique effectively applied to evaluation of the value of individual companies using an information processing system.

2. Description of the Related Art

An example of this type in related art is JP 11-328287 A. In the related art in this publication, a plurality of evaluation criteria (a category share criterion, a consumer ID share criterion and a channel share criterion) for rating a brand are calculated, these evaluation criteria are then subdivided into a plurality of divisions, and each brand is classified into one of the divisions for each evaluation criterion, to thereby rate the brand with a comprehensive evaluation score produced from the sum of the respective evaluation scores.

On the other hand, there is a technique which uses a customer value map. This technique is based on the idea that, the level of monetary contribution to a product in a specific market depends on the amount of the product, which is purchased by individual customers or households. In this method, customer codes, product codes, amounts and the like in the case where the customer purchases the product in the particular market are collected for a given duration of time, and this data serves as a basis to execute a purchase amount classification step which classifies the customers into m number of layers. Next, since the customer's loyalty or degree of attachment to each brand of the product depends on the concentration of varieties of purchased brands, the above-mentioned data is used to perform a brand purchase concentration level classification step which classifies the customers again into n number of layers. Then, the customers are mapped according to these two classification steps.

Further, models for measuring brand strength which are generally used can be divided into models referred to as “financial data methods”, and models referred to as “question survey methods”.

The former is an approach which estimates brand value based on financial data such as sales, profits, corporate stock market capitalization, intangible values and the like. Known examples include NCI research (a Northwestern University research project), Knowledge Capital Scoreboarding (by Professor Lev at New York University), and models developed by strategic consulting companies.

The latter is an approach which uses question sheets and questionnaire surveys to extract images that customers have regarding a brand to estimate the brand strength. This approach is used by many advertising agencies. The two related arts discussed above both belong to this latter approach.

However, the models for measuring brand value which have been developed up until now are unsatisfactory with respect to the following 3 points:

First, the majority of the conventional models depended on either the question survey method or the financial data method. However, brands create value by exerting influence on stakeholders' image of the company and on the stakeholders' actions, by which the company's financial values are then affected. Therefore, both the methods should be considered when measuring the brand value.

Second, the conventional models did not clarify the mechanism(s) by which the corporate brand produced value.

Third, focus was placed only on the influence that the brand has on the customer, without clarifying the influence exerted on the employees, the stockholders and the other stakeholders.

### SUMMARY OF THE INVENTION

The present invention has been made in light of the points mentioned above, and therefore has a technical object to propose a brand value evaluation model which shows the value of a corporate brand as a monetary value, thus providing a scheme capable of appropriately evaluating investment(s) in branding activities.

The present invention evaluates the economic effect produced by the strength/depth/breadth of the brand image in the minds of stakeholders such as customers, employees and stockholders along three axes of premium, recognition and loyalty, and it expresses the brand's power to generate future cash flow with one comprehensive evaluation score (i.e., a corporate brand score, referred to as a “CB score”).

The “corporate brand” concept proposed by the present inventors refers to an intangible individuality that determines the image that the stakeholders have of the company and/or group. It is a factor which distinguishes the company from other companies and conveys to people an overwhelming sense of the company's presence and a sense of reliability.

### BRIEF DESCRIPTION OF THE DRAWINGS

In the accompanying drawings:

FIG. 1 is a system architecture diagram according to the present invention;

FIG. 2 is a processing flow chart according to an embodiment;

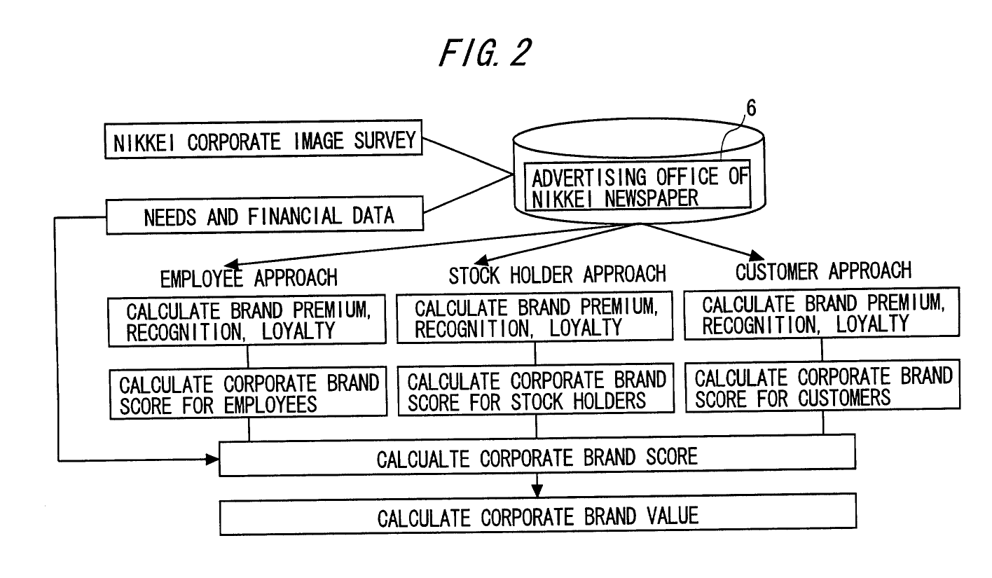

FIG. 3 is a diagram showing an example of calculation of a premium indicator according to the embodiment;

FIG. 4 is a diagram showing an example of calculation of a recognition indicator according to the embodiment;

FIG. 5 is a first diagram for explaining a method of calculating a loyalty indicator according to the embodiment;

FIG. 6 is a second diagram for explaining the method of calculating a loyalty indicator according to the embodiment;

FIG. 7 is a third diagram for explaining the method of calculating a loyalty indicator according to the embodiment;

FIG. 8 is a first diagram showing an example of calculation of the loyalty indicator according to the embodiment;

FIG. 9 is a second diagram showing an example of calculation of the loyalty indicator according to the embodiment;

FIG. 10 is an example of calculation of customer, employee and stockholder scores according to the embodiment;

FIG. 11 is a formula for calculating a corporate brand score according to the embodiment;

FIG. 12 is a first diagram of an example of calculation of the corporate brand score according to the embodiment;

FIG. 13 is a second diagram of an example of calculation of the corporate brand score according to the embodiment;

FIG. 14 is a specific example of corporate brand capitalization ability according to the embodiment;

FIG. 15 shows a formula for converting an corrected CB score to a CB value according to the embodiment;

FIG. 16 is a formula for converting the corrected CB score to the CB value using a B/S method according to the embodiment;

FIG. 17 is a formula for converting the corrected CB score to the CB value using a P/L method according to the embodiment;

FIG. 18 is a formula showing integration of the B/S method and the P/L method according to the embodiment; and

FIG. 19 is a diagram presenting the corporate branding concept according to the present invention.

### DETAILED DESCRIPTION OF THE PREFERRED EMBODIMENTS

Hereinafter, explanation is made of an embodiment of the present invention based on the drawings.

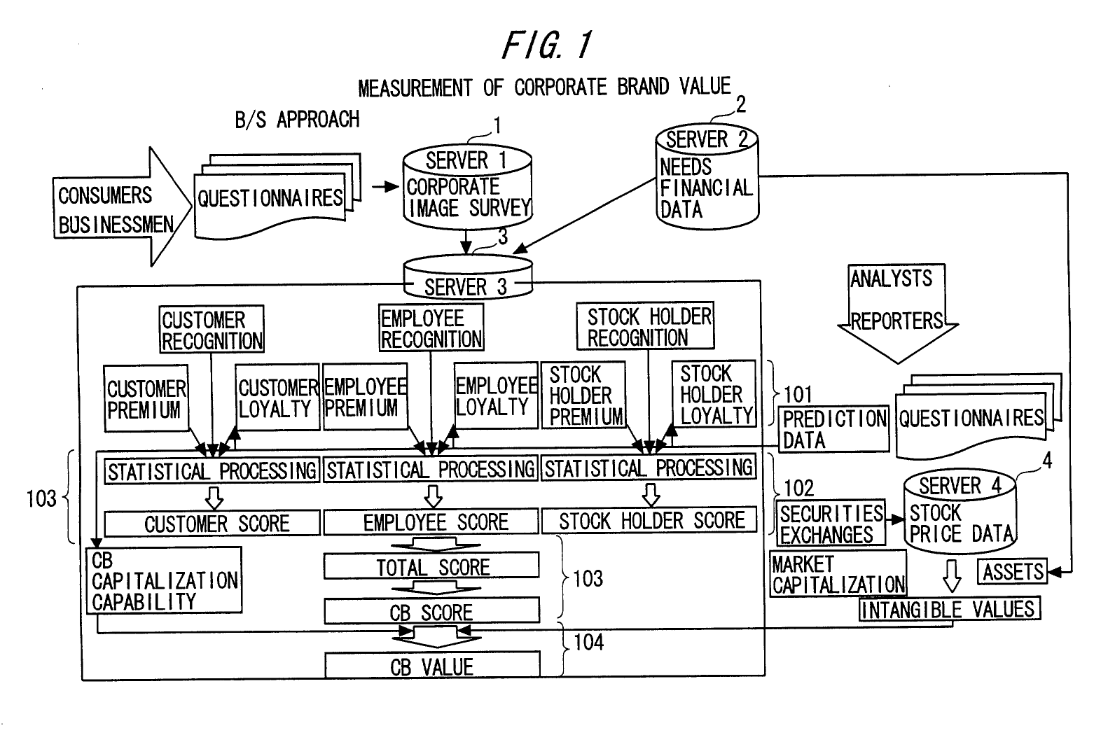

FIG. 1 is a block diagram showing processing of an information processing system for measuring a corporate brand value (referred to as a “CB value”), which shows an embodiment of the present invention.

A server 1 is a server which totals up corporate image survey results. Questionnaire results which have been obtained from consumers and the like according to a question survey method are inputted into the server 1. The questionnaire may be administered by asking verbally, by writing on a paper medium, or via a direct input into the server from a user terminal via a network, or the like.

Numerical values indicating evaluations for such categories as “has tradition”, “easy to get to know”, and “stable” are registered in the server 1.

A server 2 is a server for processing/totaling financial data. Operating profits, sales, personnel costs, costs for welfare facilities, corporate stock market capitalization, book value of net assets (adjusted), liquid assets, cash, securities, current liabilities, short-term debts, corporate bonds maturing within 1 year, total debt, owner's capital, number of employees at the end of the term, number of issued stocks, information regarding market price of securities and other such data are stored in the server 2.

A server 3 is a processing unit forming the core of this embodiment. In a first step, the server 3 calculates premium indicators, recognition indicators and loyalty indicators each for clients, employees and stockholders. Here, the premium indicator is calculated based on operating profits, sales and other such financial data, and the recognition indicator and the loyalty indicator are calculated based on corporate image survey results (step 101).

In a second step, scores are calculated for the customers, the employees and the stockholders based on the respective indicators calculated as described above. These scores are calculated by multiplying the premium indicator, the recognition indicator and the loyalty indicator (step 102).

In a third step, information included in the customer-, employee- and stockholder-scores is compiled in one indicator, and this score is assumed to be information derived from the corporate brand. This indicator serves as a CB score (step 103).

In a fourth step, the company's ability to link the corporate brand to the future cash flow (i.e., the corporate brand capitalization ability, referred to as “CB capitalization ability”) is expressed as an index (step 103′).

In a fifth step, the CB value (in monetary terms) is estimated from the relationship among the intangible values, the CB capitalization ability and the CB score (step 104).

Note that, in a server 4 are registered stock price data which is obtained from securities exchanges, such as corporate stock market capitalization and asset values. These are treated as intangible values used in calculating the CB value from the CB score.

Below, explanation will be made regarding details of each step performed by the server 3.

(Calculation of the Premium Indicator)

When selecting the premium indicator, the main information used is the financial data stored in the server 2. This is because it is difficult to collect voluminous samples in the question survey, and even if such could be collected, the precision of the data would be dubious. Rather, the financial data for the company is considered to be more likely to express the truth about the company.

A price premium can be used as one standard to judge whether targeted customers are being drawn in or not. However, price premiums vary depending on the product/service, and production costs used to calculate the price premiums also frequently vary depending the product/service. Therefore, ROS (return on sales) is used as a substitute variable for the price premium, and serves as a customer premium.

Whether or not the company has attracted superior employees can be judged based on how much the employees contribute to improvement of productivity, development of new products and improvement of customer satisfaction. However, it is difficult to extract these in an objective way. Therefore, employee's productivity (calculated as operating profits/(personnel costs, welfare facility's costs, etc.)) is used for an employee premium.

Further, in order to decrease stockholders' capital costs, it is essential to have stockholders who keep their stocks in a long-term and stable fashion regardless of reports in news. Here, when a corporate stock market capitalization level remains higher than its net assets, it is judged that the company has succeeded in holding onto its stockholders, and PBR (price-book value ratio) is selected as a stockholder premium indicator.

Incidentally, financial ratios differ from industry to industry. Therefore, each of the variables is expressed as a score (i.e., standardized, regularized) in a way of reflecting the company's relative position within its industry. A standard deviation and an average value which are used to calculate a percentile are calculated based on industry pool data (accumulated over the last 13 years, from 1988 through 2000).

Further, the price-book value ratio (PBR) can be expressed as (corporate stock market capitalization at end of term/book value of net assets). However, it must be remembered that the level of the company's price-book value ratio often can be greatly influenced by the company's financial leverage. This is why the price-book value ratio in the case where the equity capital ratio is on par with the industry average is used as the indicator for the stockholder premium. Therefore, a corrected price-book value ratio is calculated as follows:

Corrected price-book value ratio (PBR)=corporate stock market capitalization at end of term/[book value of net assets×(industry average equity capital ratio/equity capital ratio in the company in question)]

Note that, regarding the corrected PBR, the samples typically concentrate near 1. In order to reduce the influence of this phenomenon, the corrected PBR is logarithmically converted and adjusted so that the proportionate differences among the companies widen.

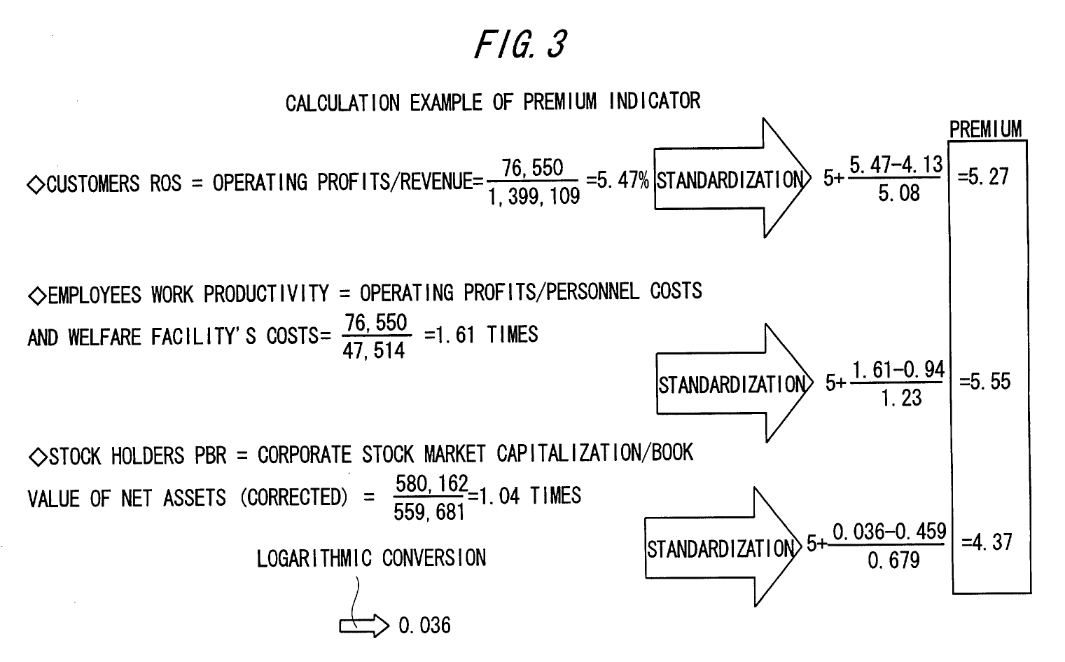

FIG. 3 shows a specific example of the calculation of the premium indicator described above, using a company A as an example.

(Calculation of the Recognition Indicator)

What is mainly used for calculating the recognition indicator is the corporate image survey data in the server 1. In the corporate image survey, there were calculated a “customer recognition indicator”, an “employee recognition indicator”, and a “stockholder recognition indicator”, which were understood as indicating the “breadth/distribution of stakeholders that have been successfully established”.

The technical concept behind the customer recognition indicator is that an indicator should be calculated which reflects how many customers are thinking, “I want to do business with that company”, or “I want to continue doing business with that company”. However, there are many instances where such an indicator is not present in the company image survey. Therefore, a category of general “favorable impression” toward the given company is used as a substitute variable for this indicator.

The employee recognition indicator should be calculated which reflects how many employees are thinking they want to be employed by the company or want to continue working at the company. According to the present model, a category of “employment intention” in the company image survey is considered to correspond to this indicator, and this is used as the employee recognition indicator.

The stockholder premium indicator should be calculated which reflects how many stockholders want to purchase stocks in the company or want to continue holding their stocks in the company. According to the present model, a category of “intention to purchase stock” in the company image survey is considered to correspond to this indicator and is used as the employee recognition indicator.

Note that, in the case of a B2B (business to business) enterprise, the customers will be businessmen, and in the case of a B2C (business to consumer) enterprise, the customers will be general people. Therefore, it is appropriate to modify the company image survey accordingly.

Note that, in the calculation of the recognition indicator, each variable is expressed as a score (i.e., standardized) to establish the variables' relative positions within the given industry in consideration of the calculation of the above-mentioned premium indicator per industry. The standard deviation and an average value necessary for calculating the percentile are calculated based on industry pool data (i.e., covering the past 6 years from 1995 through 2000).

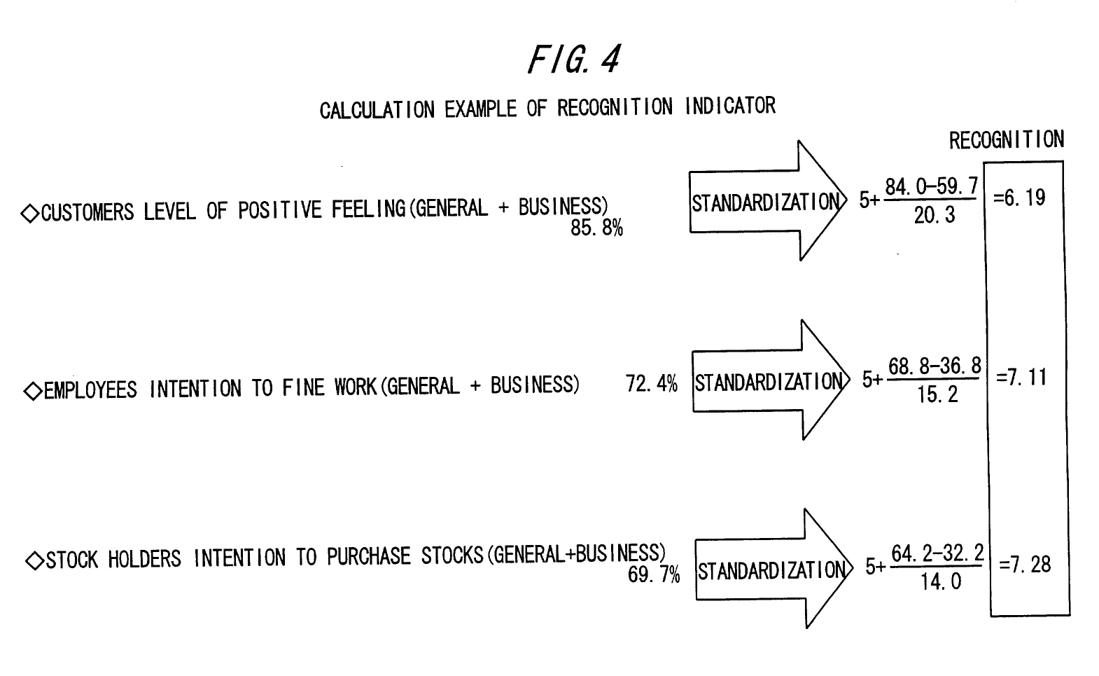

FIG. 4 explains the calculation of the recognition indicator using a company A as an example.

(Calculation of the Loyalty Indicator)

When calculating the loyalty indicator, first, relationships between the financial ratios and 25 categories regarding the company image over the past 12 years, (e.g., 1988-1997, 1988-1998, 1990-1999) are carefully and minutely analyzed.

Next, the matrix of coefficients of correlation as calculated above is used to create an image ranking chart. For each of the “images”, the extent of the correlation to the level of loyalty is shown as a score based on this ranking chart.

Next, at hearings with analysts and industry personnel, the image categories which are likely to be evaluated highly in the future noted at these are turned into data.

Special attention is paid to the image categories which are intimately related to the loyalty level, and a principal component analysis is performed to synthesize/integrate the categories into 1 indicator.

Specifically, constants established for categories of “ability to grow”, “tradition”, “vitality”, “individuality” and the like are multiplied by numerical values and a value calculated by adding these together is standardized to thereby produce the single loyalty indicator.

There are 25 categories used to calculate the loyalty indicator, including “easy to get to know”, “passionate about responding to customer needs”, “good publicity activities”, “operations/sales capability”, “sensible taste”, “individuality”, “R&D/product development capabilities”, “technical strength”, “product/service quality”, “vitality”, “ability to grow”, “globalized”, “passionate about culture/athletics/events”, “passionate about entering new fields”, “response to social changes”, “superior human resources”, “superior management”, “financials”, “stability”, “tradition”, “reliability”, “speedy management”, “self-reinventiveness”, “passionate about disclosing company information”, “sensitivity to environment”, etc.

Further, the financial data includes customer categories including a sales fluctuation coefficient, an operating profit fluctuation coefficient, a ROS (return on sales) average, standard deviation, sales and growth, operating profits, growth, etc.

Further, employee categories include a fluctuation coefficient in the number of employees at end of the term, growth, employee's productivity (=operating profit/personnel costs and welfare facility's costs) average, standard deviation, etc.

Further, stockholder categories include a fluctuation coefficient in corporate stock market capitalization, growth, a PBR average, standard deviation, etc.

Note that, the fluctuation coefficients and averages are calculated based on achievements from 1988 to 1999, and the employee's productivity is calculated using continuous data (although individual data is used when continues data is unavailable). Further, the growth is calculated as an index (=1999 achievements/1988 achievements).

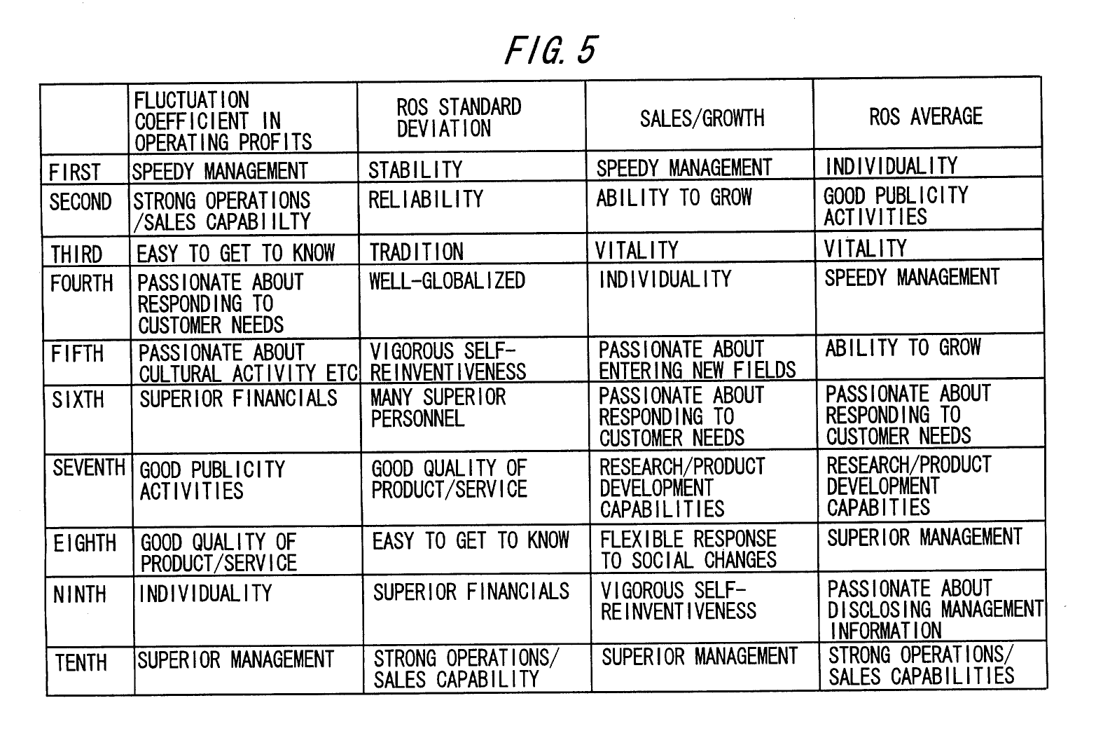

A general purpose spreadsheet calculation program is used to calculate a matrix of coefficients of correlation for the 25 categories pertaining to the company image and the 14 categories pertaining to the financial values. Then, 4 financial value categories exhibiting coefficients of correlation perfectly reflecting a hypothesis (i.e., the hypothesis is that risk categories will exhibit negative correlations, and growth and average categories will exhibit positive correlations) are picked out from the customer categories, from the employee categories and from the stockholder categories. Then, a ranking chart is created according to the coefficient of correlation with the sign intended for each of the categories (See FIG. 5).

Next, the above-mentioned matrix of correlation coefficients for the 25 company image categories and the financial value categories (relating to the customers, the employees, and the stockholders) is examined, and the financial ratio categories exhibiting correlative coefficients which correspond well with our hypothesis are picked out from the customer, employee and stockholder categories (8 to 9 categories each).

Then, ranking according to degree of correlation is determined for each of the above-mentioned categories according to the sign intended in our hypothesis.

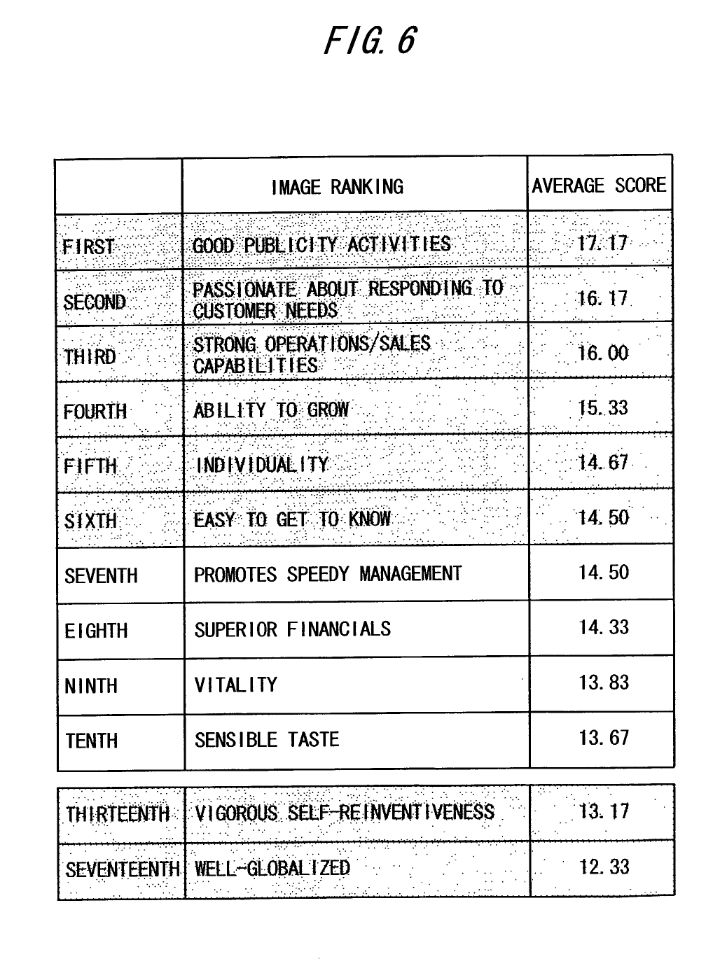

Next, the points for the image categories intimately connected with brand loyalty are displayed based on the ranking chart. Specifically, a score of 25 points is displayed for the most intimately connected category, 24 points for the second . . . and 1 point for the 25th are displayed, and 8 or 9 categories with the highest average points per stakeholder are picked out (See FIG. 6).

The foregoing processing enables extraction of the image categories that are most deeply connected to loyalty based on past financial data. However, with respect to the loyalty indicator, attention needs to be paid to whether or not each stakeholder can be attracted and maintained in the future. On the one hand, it is a fact that the future is an extension of the past. On the other hand, it is a fact that the kinds of images that are taken seriously change with the times. Therefore, in addition to picking out the image categories based on the relationship with the past data, it is also possible to pick out the image categories which are likely to be taken seriously in the future.

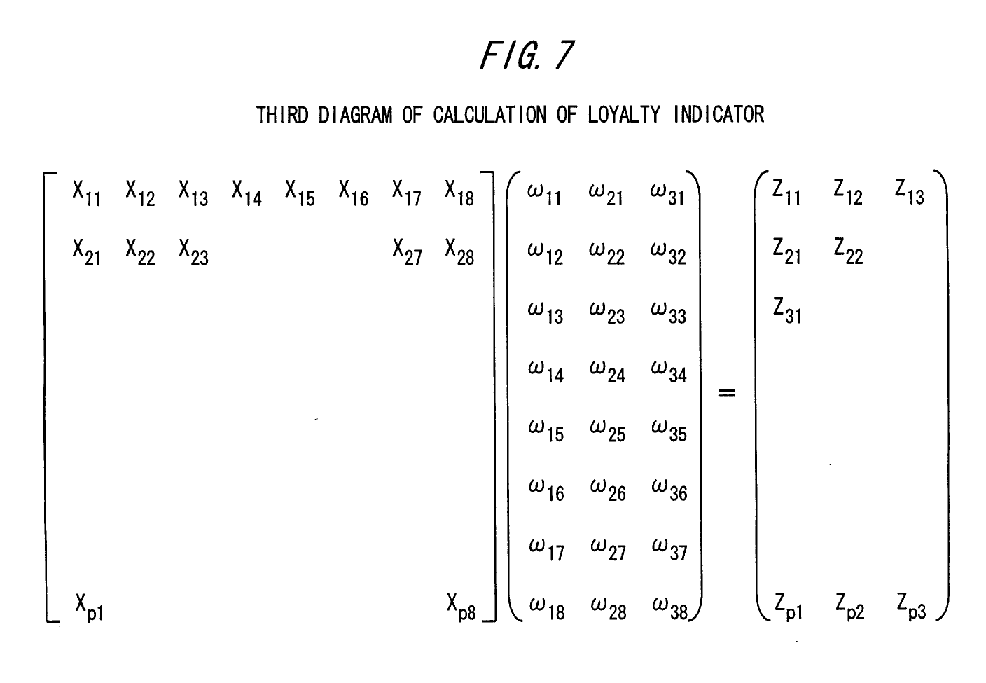

Next, as shown in FIG. 7, the images that were picked out in the previous steps are selected to serve as variables x1 to x7, and a principal component analysis is performed using a statistical module (SPSS). Component matrices are calculated for the respective variables, and the loyalty indicator is calculated from these. Here, 3 or 4 principal components (i.e., each component with a factor load of 1 or greater and a percent contribution of 75% or greater after rotation of the principal component) are judged as important for expressing the level of loyalty, and these are added to the variables.

The loyalty indicator calculated as described above is converted to a percentile (a value calculated by adding a value of 5 to a standard variable). Percentiles relating to the loyalty indicator are measured respectively for the customers, the employees and the stockholders.

Note that, the standard deviations and averages that are needed to calculate the percentiles are calculated based on industry pool data (i.e., from the past 6 years, from 1995 through 2000).

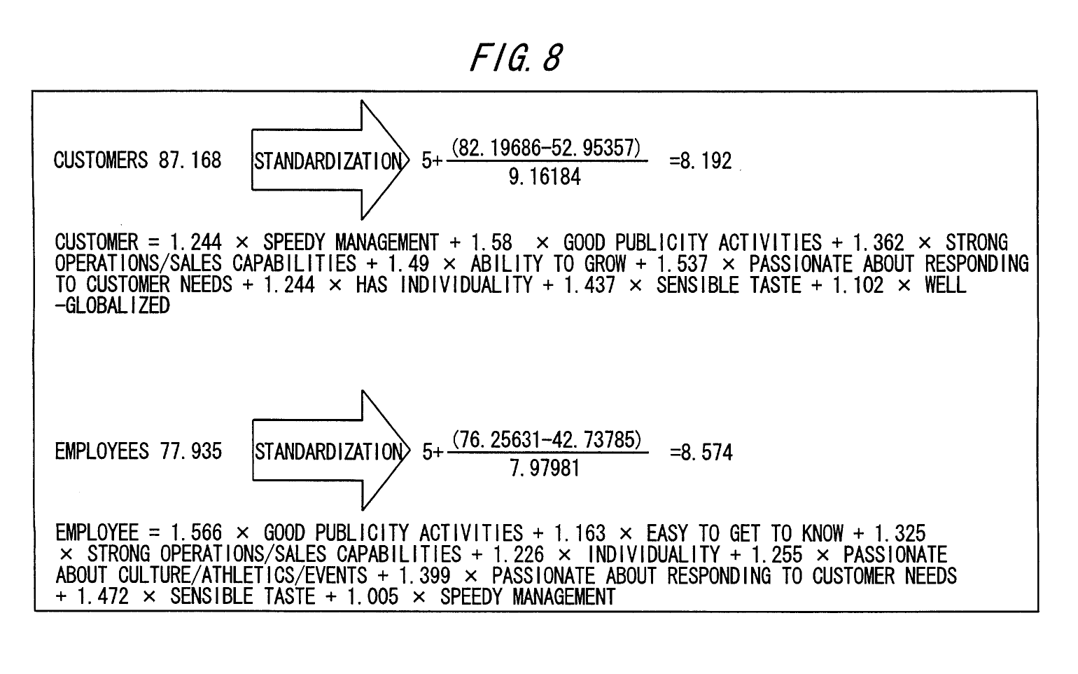

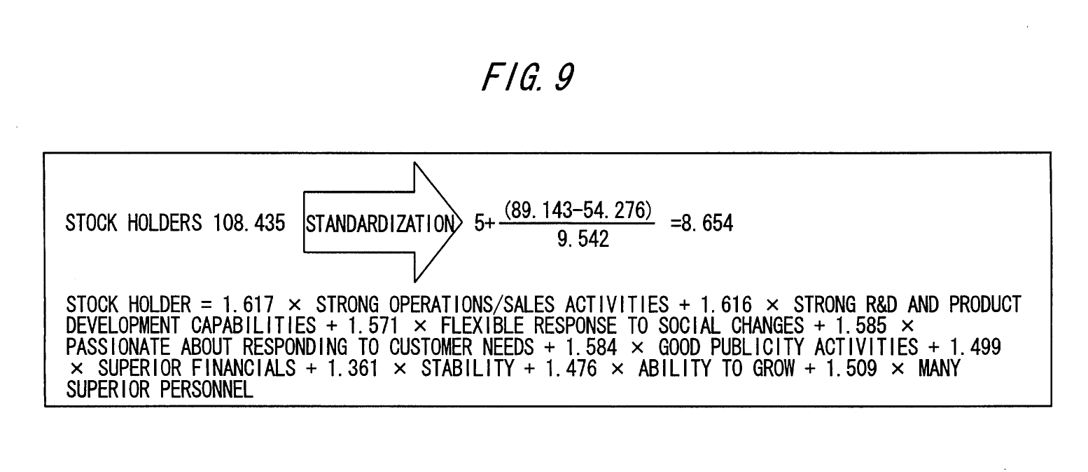

FIG. 8 and FIG. 9 are specific examples of the loyalty indicator calculation performed for a company A.

(Calculation of the Customer, Employee and Stockholder Scores)

The stakeholder scores are calculated to express how much each stakeholders' thought and image in mind about the brand may contribute to the creation of cash flow in the future.

The corporate brand value will not increase without raising the premium score, the recognition score and the loyalty score as a whole. Even if the recognition and loyalty scores are high, when the premium score is in the negative, the brand value rather has a possibility of being in the negative. Therefore, the 3 indicators are multiplied together, and the corporate brand with the higher score is determined as having the greater possibility of creating cash flow in the future.

In other words, stakeholder scores for the customers, the employees and the stockholders are obtained by multiplying the value of the premium indicator, the value of the recognition indicator, and the value of the loyalty indicator.

Here, as shown in FIG. 1, the scoring is calculated for each type of stakeholder (i.e., the customers, the employees and the stockholders) in order to use the present measuring model as an integrated corporate branding valuator system. In order to promote corporate branding, it is essential to convey the message of the corporate brand to the customers, to the employees and to the stockholders, and it is also essential to strive to convert that message into appeal or value. It is necessary to measure the brand score for each of the stakeholders (i.e., the customers, the employees and the stockholders) in order to identify which stakeholder the message is losing appeal for.

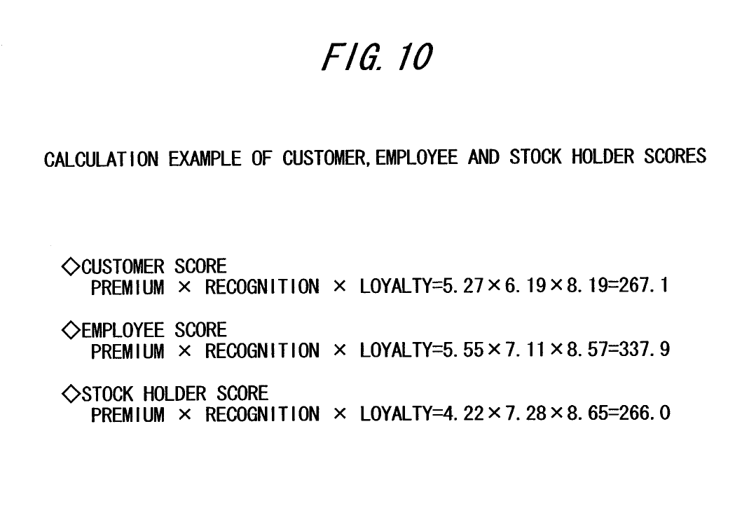

FIG. 10 shows a calculation example of a customer score, an employee score and a stockholder score for the company A.

(Calculation of the Corporate Brand Score)

The customer score, the employee score and the stockholder score calculated above each indicate the strength/depth of each stakeholders' thinking about the corporate brand, and the breadth of people who share this. Simultaneously, they indicate how likely the thoughts and images will produce cash flow in the future.

What kind of company has an overall strong corporate brand?

The following 2 approaches exist for measuring the corporate brand's overall strength.

(1) Hypothesizing the importance of the customer score, the employee score and the stockholder score

The importance of each stakeholder differs in each theorist or from industry to industry. However, since the survey is conducted so as to target a considerably wide range of companies, it is difficult to reflect the circumstances of each company and each theorist's opinions in the survey. Therefore, the customer score, the employee score and the stockholder score are simply added together, and the sum is treated as the CB score reflecting the overall strength of the corporate brand.

(2) Turning the customer, employee and stockholder scores into a general indicator by principal component analysis

Principal component analysis is utilized to create a single indicator while preserving as much of the information included in the customer score, the employee score and the stockholder score as possible.

Here, the convenient approach (1) mentioned above is used, but a method of use in an approach (2) will be introduced.

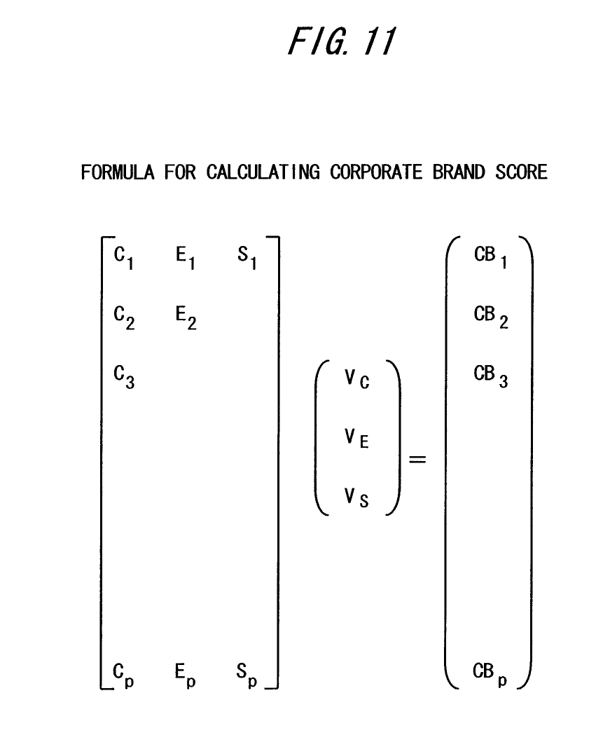

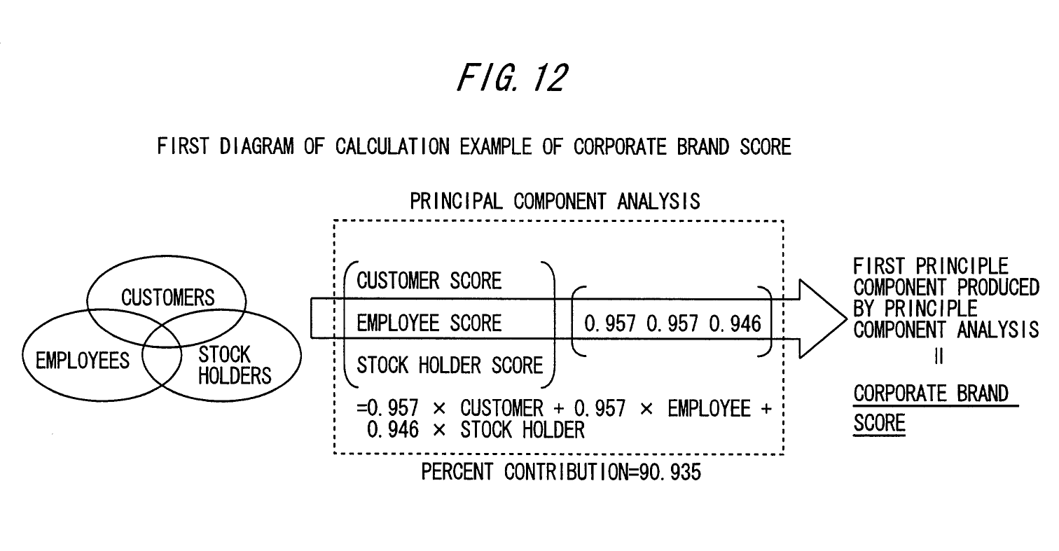

The process of using the principal component analysis to create the comprehensive indicator for the customer score, the employee score and the stockholder score is shown in FIG. 11 and FIG. 12.

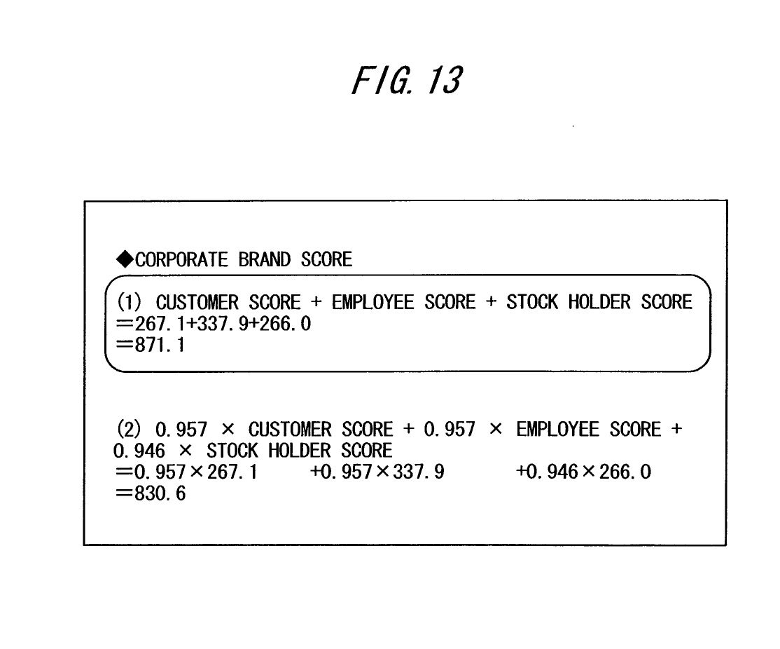

FIG. 13 shows corporate brand scores obtained by using approach (1) and approach (2).

Specifically, the customer score (Ci), the employee score (Ei) and the stockholder score (Si) for each company are inputted, and statistical software (SPSS) is used to calculate a component matrix for the variables. Just a first principal component is extracted, and this is treated as the corporate brand score (CB score). This is expected to have a percent contribution of about 80% or greater.

Here, the premium indicator and the loyalty indicator, which comprise the elements of the customer score, the employee score and the stockholder score, express relative positions within the company's industry. Therefore, the component matrices necessary for calculating the CB score are also calculated per industry.

Then, an adjustment coefficient for the industry is calculated based on the sum (íC+íE+íS) of the component matrices of each industry. This adjustment coefficient is effective for comparatively understanding CB scores which exceed the boundaries between industries.

(Calculation of CB Capitalization Ability)

The CB score reflects the relative position of the overall strength of the corporate brand in the industry. However, it needs to be noted that a high CB score does not necessarily guarantee that the corporate brand will produce a high future cash flow level. This is because even if the CB score is high, there are cases in which the company does not have the ability to effectively convert the corporate brand into cash flow because the company's business model is not solidly structured or because the infrastructure for capitalizing on the brand is not established. The ability to convert the corporate brand into a future cash flow is called corporate brand capitalization ability (referred to as “CB capitalization ability”).

The following two facts are considered when calculating the CB capitalization ability.

(1) In the company's balance sheet, the company's intangible assets such as its corporate brand are accounted for. On the other hand, the company's profits which are made out of the company's corporate brand and other such intangible assets (mainly accounted for as its operating profits) are reflected in the calculation of the company's profits and losses. Therefore, the ROA is calculated using the company's balance sheet's business assets as the denominator and its profits and losses statement's operating profits as the numerator, and the company with the more profit from its intangible assets will exhibit a higher ROA level.

The corporate brand is one of the main elements of the company's intangible assets. Therefore, a company, which is able to make profits from its corporate brand, tends to have a higher ROA than a company which is unable to do so.

(2) However, the company operating profits in the numerator in the ROA (operating profits/business assets) calculated in item (1) include both business assets accounted for in the balance sheet and profits made from the company's intangible assets except its corporate brand which are not accounted for in the balance sheet. Therefore, the level of the profits resulted from the corporate brand cannot be measured with only the ROA level. It is necessary to deduct the influence of the other intangible assets, or identify the portion of the ROA level which is figured to have been resulted from the corporate brand.

Based on the above, the CB capitalization ability is defined according to the following process.

(1) The ROA (operating profit/company assets) is measured for each company. Incidentally, in order to include the influence of recent data, the following weighting is applied:

4 years ago:3 years ago:2 years ago:1 year ago:immediate past=1:2:3:4:5

(2) A coefficient of the correlation between an ROA fluctuation value and a CB score fluctuation value ((CB score(t)−CB score (t−1)/CB score (t−1)) is calculated per company or per category.

(3) The coefficient of correlation calculated at (2) described above expresses a part of the ROA fluctuation value which can be explained by the CB score fluctuation value. If this value is multiplied by the ROA, it is possible to clarify how much of the ROA level can be accounted for by the corporate brand.

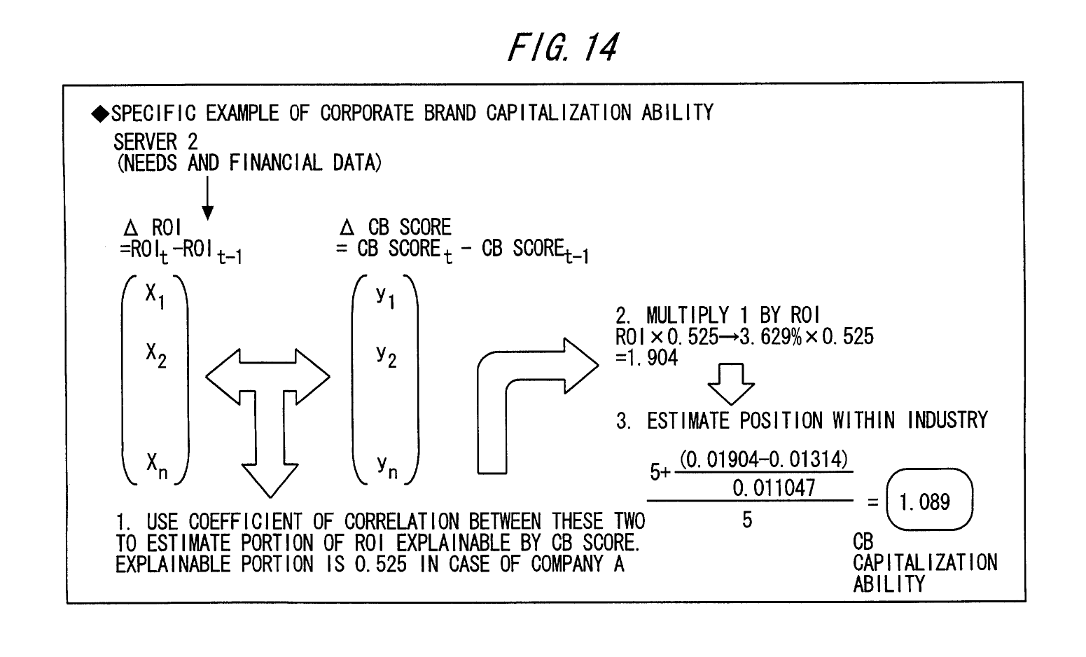

FIG. 14 shows a specific example of calculating the CB capitalization ability for the company A.

The CB capitalization ability serves a role of adjusting the CB score. This is because the creative power of the future cash flow cannot be effectively reflected with just the CB score. The CB capitalization ability is designed such that 1.0 is the average, a company, which has the ability to capitalize on the corporate brand, has a value that exceeds 1, and a company which lacks the ability has a value less than 1.

(Conversion of the Corrected CB Score to CB Value)

The corrected CB score calculated by multiplying the CB score by the CB capitalization ability can be understood as being an indicator reflecting “the creative power of the future cash flow coming from each stakeholders mental attachment to the corporate brand (measured as a relative position within the industry)”.

$$\begin{matrix}Corrected CB score = CB score \times CB capitalization ability \\ = 839.551 \times 1.440 \\ = 1 , 208.756\end{matrix}$$

The CB capitalization ability can be estimated from the relationship between the past ROI and the CB score with the above processing. However, it is also essential to qualitatively define the characteristics exhibited by companies which do have the CB capitalization ability. In order to do so, the following types of questions are asked in surveys of experts to define the CB capitalization ability based on qualitative aspects, and these need to be incorporated into factors for determining the CB capitalization ability:

(1) The management are evangelists for the corporate brand;

(2) The corporate brand is effectively being used for communication;

(3) The company's vision and values correspond with the image of the corporate brand;

(4) A business model is established for carrying out the values projected in the corporate brand;

(5) The employees understand the corporate brand and importance is placed on actions rooted in understanding of the corporate brand.

Next, the survey of experts is scored, and industry samples are divided (into 3 to 5 divisions depending on the number of samples) according to companies with the highest scores. Coefficients of correlation between Ä ROI and Ä CB score are calculated for each category, and the coefficients of correlation can be multiplied by the ROI to calculate the CB capitalization ability.

The corrected CB score is an indicator reflecting how much power the company has to create future cash flow from the corporate brand. However, the corrected CB score represents the relative position within the industry, and following 3 premises must be in place to convert this into the CB value which is expressed as a monetary unit.

(Premise 1)

The CB value is one main element of the company's intangible values (corporate stock market capitalization—book value of net assets—latent profits from securities), and if other conditions are identical, the company with the higher corrected CB score will have intangible assets occupying a greater portion of the corporate stock market capitalization.

The company's future net cash flow level is reflected in the corporate stock market capitalization. Moreover, the size of the company's future net cash flow creation is evaluated on the stock market and projected in the corporate stock market capitalization. The proportion of this which is accounted for by the future net cash flow part from the corporate brand is determined by the degree of the brand strength. For a company evaluated by the stock market as having a large future cash flow from its corporate brand, the weight occupied by its tangible assets such as the book value of net assets and latent profits from securities in the corporate stock market capitalization will naturally become smaller.

(Premise 2)

It is imagined that the company has intellectual capital, customer value, organization-wide assets and other intangible assets other than the CB value. In other words, when estimating the CB value, it is necessary to extract from the intangible values only that portion which is produced from the corporate brand. However, a process for doing so is not easy.

The inventors used a coefficient of correlation between the past CB score fluctuation value and the past intangible values fluctuation value to estimate the “portion of the intangible value fluctuation which can be explained by the fluctuation of the CB score”, then made an assumption that the given coefficient of correlation will become equal to the proportion that the CB value occupies among the intangible values possessed by an average company in that industry, and then performed our analysis.

The CB value is 1 element of the intangible values, and the CB value and the intangible values are not the same thing. However, the monetary value of the intangible values other than the CB value has not been clarified, and it is difficult to estimate what proportion of intangible values is accounted for by the CB value. Therefore, the inventors decided to derive a given estimated proportion based on the relationship (i.e., the coefficient of the correlation) between the past CB score fluctuation value and the past intangible values fluctuation value. Since the coefficient of the correlation is obtained for each industry sample, the estimated proportion which is ultimately calculated is the proportion of the intangible values occupied by the CB value in the average company in that industry

First, the coefficient of the correlation between the past CB score fluctuation value and the past intangible values fluctuation value is obtained for each sample (for each industry). The value thus produced indicates what percentage of the intangible values fluctuation portion can be explained by the fluctuation of the past CB score for the average company in the same industry. This value clarifies what portion of the fluctuation in the intangible values is determined by the fluctuation of the CB value, and what portion is the influence of the other intellectual capital, the customer value and the like. Therefore, it is assumed that if the given correlation coefficient is used, then the proportion of the intangible values occupied by the CB value in the average company in the given industry (from among the sample) can be estimated. Then, the analysis is performed based on this assumption.

Specifically, the relative relationship between the Ä CB score ((CB score (t)−CB score (t−1))/CB score (t−1)) and Ä intangible value ((intangible value(t)−intangible value(t−1))/intangible value(t−1)) is calculated first based on the pool data (1997 to 2000) of the sample overall (i.e., per industry).

Next, the coefficient of correlation is multiplied by the intangible value possessed by each company within the sample (i.e., for the industry on the whole from 1995 to 2000) to estimate the part of the intangible value which is considered to be the CB value.

(Premise 3)

The corrected CB score is basically a numerical value accumulated by expressing a ratio as a standardized variable, so it is difficult for this numerical variable to appropriately reflect differences in the sizes of the companies. Therefore, the numerical value calculated based on Premise 2 (i.e., intangible value×Ä CB score·Ä intangible value·coefficient of correlation) is divided by an “enterprise value” (i.e., corporate value).

However, the corporate stock market capitalization or the corporate stock market capitalization which constitutes the corporate value is influenced by temporary economic fluctuations. Therefore, either the corporate stock market capitalization that will be used is calculated based on the stock price from the 2 months before and after the end of the accounting period, and also the corporate stock market capitalization or corporate value that will be used is used only after applying the following weighting:

Total market capitalization or corporate value 4 years ago:3 years ago:2 years ago:1 year ago:immediate past=1:2:3:4:5

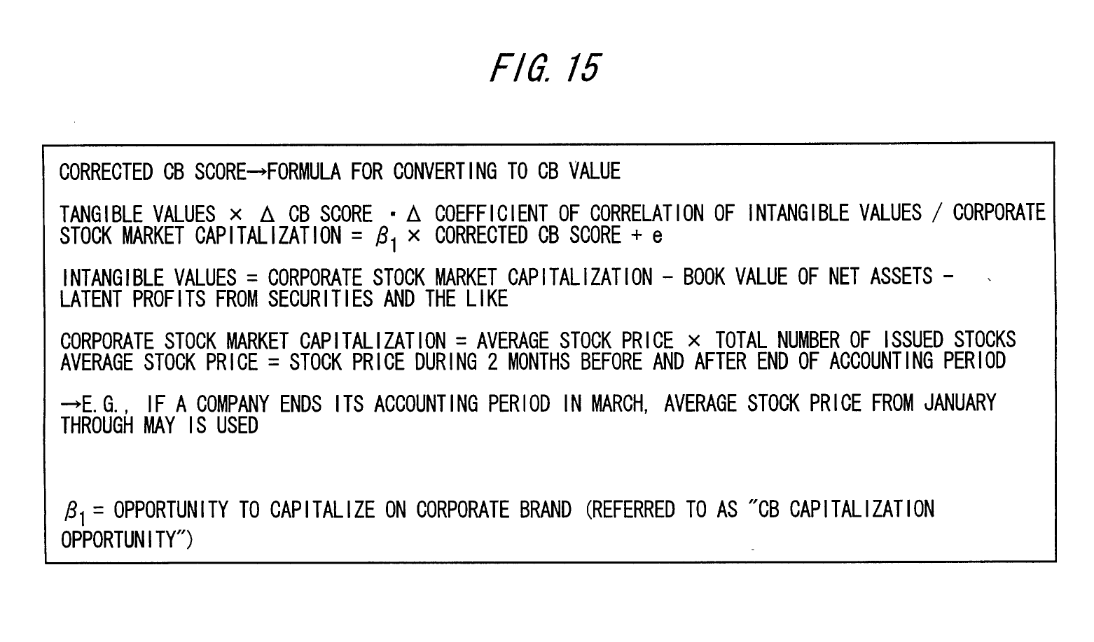

FIG. 15 shows a formula that is based on the above premises. FIG. 15 shows a formula in which the non-predictor variable is the estimated CB value (after adjustment for the scale of the company) based on the overall industry sample, and the predictor variable is the corrected CB score reflecting the future cash flow created by the corporate brand.

The formula in FIG. 15 is calculated by regression analysis based fundamentally on the industry sample. The value â1 calculated in the formula is a value which differs with each industry sample. It is inferred that this value will be greater for industries in which corporate brands are more easily linked to future cash flow. In other words, even when calculating the corrected CB score, it is surmised that the â1 value will be greater in types of industries in which high future growth is anticipated and in industries in which brand development is easy. The inventors refer to â1 as a corporate brand capitalization opportunity (CB capitalization opportunity).

An estimation is made of the proportion that the CB value occupies in the intangible values in the overall sample (by industry) on the left-hand side of the equation in FIG. 15. However, the proportion that the CB value occupies in the intangible values should basically be different for each company in the industry. In order to turn the proportions calculated per industry into values for each company, the CB value is specified only for the portion of the left-hand side of the equation which can be explained by the corrected CB score on the right-hand side of the equation.

Based on the foregoing premises, the CB value is calculated based on the following formula:

CB value=CB score×CB capitalization ability×CB capitalization opportunity×corporate stock market capitalization or corporate value

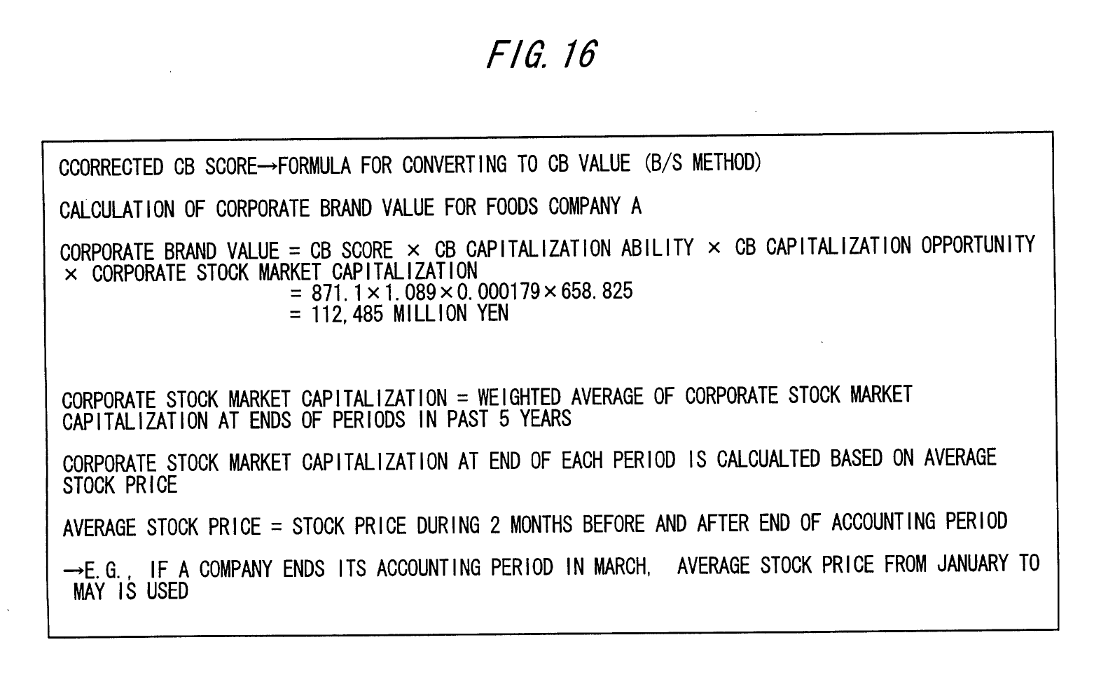

FIG. 16 shows a specific example of a foods company A.

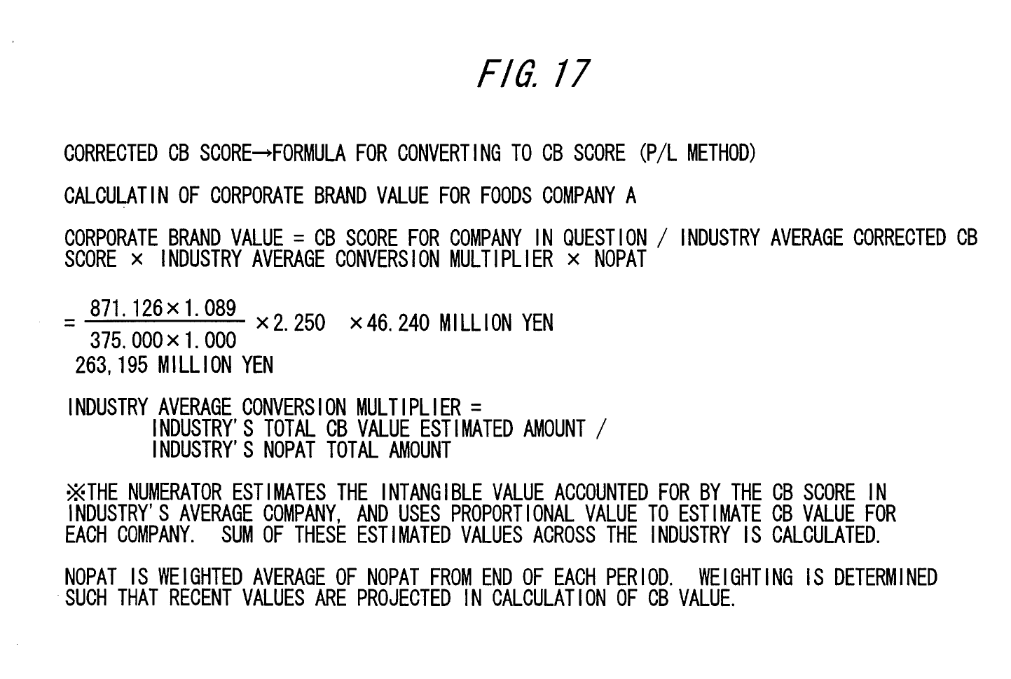

The above-mentioned concept is organized in FIG. 17. By taking this measurement at regular intervals, each company's state of progress in its corporate branding can be grasped appropriately.

The foregoing explanation converts the brand score into a monetary value based on the intangible values and the corporate stock market capitalization calculated based fundamentally on the numerical values in the balance sheet. However, since the intangible values and the corporate stock market capitalization are determined by their valuations in the stock markets, there are instances where they fluctuate due to the economic environment and other such factors not directly related to the corporate brand.

In order to minimize influences from such factors, in the present evaluation model, a monetary value conversion is performed using numerical values which are not easily affected by such influences. Specifically, the value conversion is performed mainly using the net operating profits after taxes (NOPAT), which is considered to be the number on the profits and losses statement where the corporate brand appears most effectively. Note that, this method is referred to as the “P/L method” because this method performs the monetary value conversion based on the profits and losses statement (P/L), in contrast to the “B/S method” monetary value conversion method described above which is based on the balance sheet.

First, the following 2 points need to be considered when performing the value conversion according to the P/L method: (1) What proportion of the NOPAT does the corporate brand contribute to?, and (2) How long can the corporate brand continue to generate profits? However, the above-mentioned 2 points are not directly estimated with ease. In order to overcome this problem, a multiplier method frequently used in evaluating corporations is applied. The multiplier method is an indicator represented by the PER (per earnings ratio) and the like, which is an indicator for judging an appropriate stock price with respect to the company's present profits.

When using the multiplier method, it is necessary to determine what sort of values will be used for the denominator and for the numerator. When performing the calculation, the portion that the CB value is estimated as occupying in the intangible values calculated at the end of the discussion of “Premise 2” above is used. Specifically, the estimated monetary value of the total CB value for the industry which is calculated at the end of the discussion of Premise 2 is used for the numerator, and the monetary value of the total NOPAT for the industry is used for the denominator. The multiplier calculated here estimates how many multiples of the NOPAT the CB value of the average company in the industry is equal to. For example, in the foods industry, the CB value of the average company in the industry is 2.25 times its NOPAT. This value naturally varies depending on the industry.

Next, the industry average multiplier is increased or decreased according to the brand strength of the company. Specifically, the corrected CB score for each company is divided by the average corrected CB score in that industry, and the value thus calculated is multiplied by that industry's average multiplier to thereby determine the multiplier for that company.

Finally, the CB value, which is according to the P/L method, is calculated by multiplying the company's NOPAT and the multiplier.

The above-mentioned process is as shown in FIG. 17.

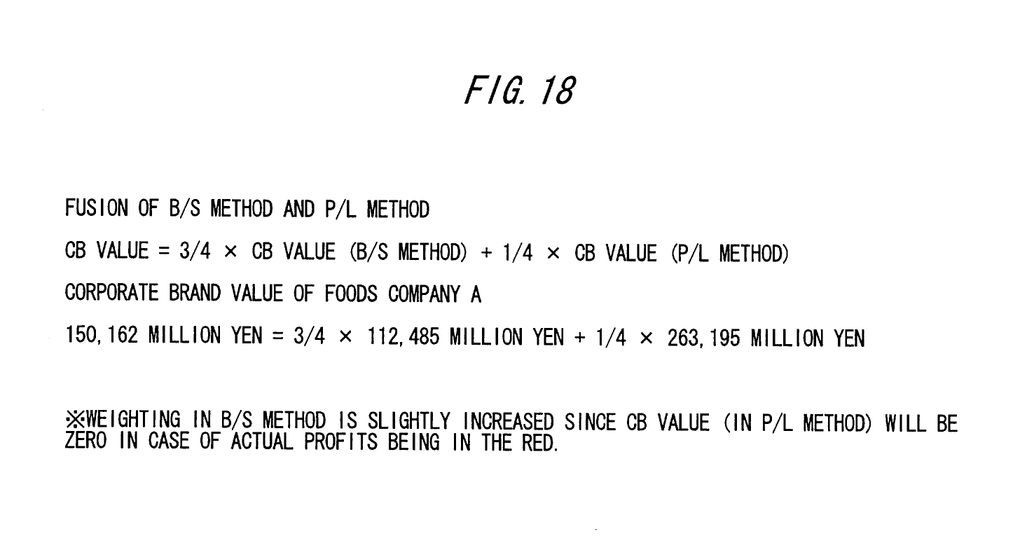

The CB value calculated by the B/S method and the CB value calculated by the P/L method are integrated to calculate the CB value. The integration is performed by integrating the CB value calculated by the B/S method and the CB value calculated by the P/L method according to a weighted average (FIG. 18). Note that an example of the integration is shown in FIG. 18. FIG. 18 shows an example in which the CB value calculated by the B/S method is multiplied by ¾ and the CB value calculated by the P/L method is multiplied by ¼. However, restriction is not made to these values. The CB value calculated by the B/S method is given with the greater weight because at present there are many companies such as banks and securities companies which are in the red but posses intangible values which are positive.

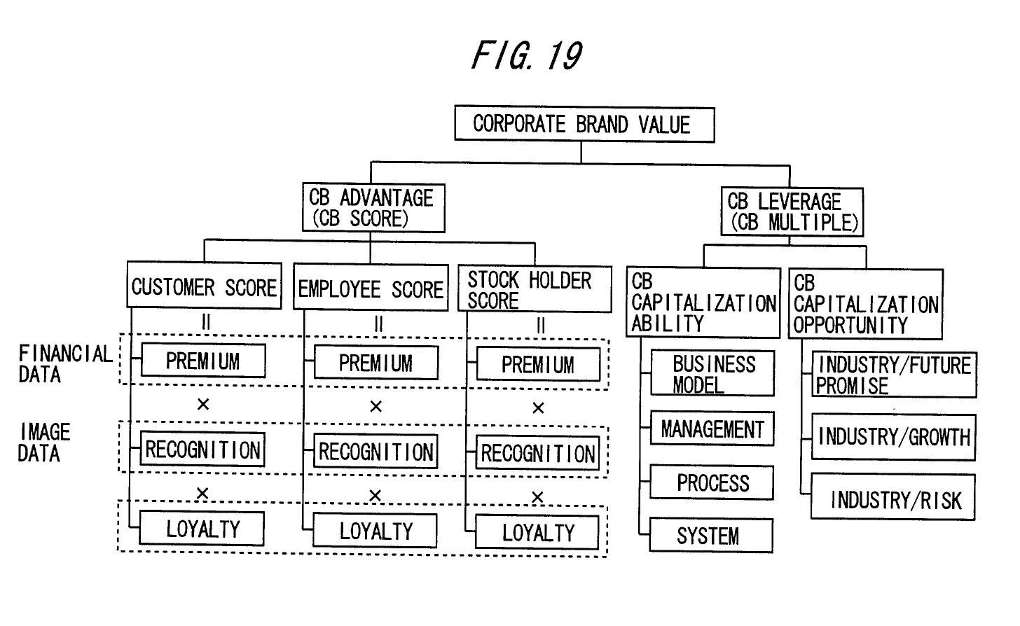

The concepts explained above are organized in FIG. 19. By measuring these at regular intervals, each company's state of progress with respect to its corporate branding can be accurately grasped.

According to the present invention, it is possible to evaluate the economic effect produced by the strength/depth/breadth of the brand image in the minds of the stakeholders such as the customers, the employees and the stockholders along the three axes of premium, recognition and loyalty, and express the brand's power to generate future cash flow with one comprehensive evaluation score (i.e., the corporate brand score).

What is claimed is:

1. A corporate value evaluation system, comprising:
a corporate image survey database storing corporate image survey data obtained from customers, employees and stockholders;
a financial database storing company's financial data; and
a corporate brand calculation processing server, wherein
the corporate brand calculation processing server:
calculates return on sales obtained mainly from the financial database, which serves as a customer premium indicator;
calculates employee's productivity (calculated as operating profits/(personnel costs, welfare facility's costs, etc.)) obtained mainly from the financial database, which serves as an employee premium indicator;
calculates a price-book value ratio obtained mainly from the financial database, which serves as a stockholder premium indicator;
calculates a level of favorable impression obtained from the corporate image survey database, which serves as a customer recognition indicator;
calculates an employment intention obtained from the corporate image survey database, which serves as an employee recognition indicator;
calculates an intention to purchase stock obtained from the corporate image survey database, which serves as a stockholder recognition indicator;
performs principal component analysis on evaluated scores obtained from the corporate image survey database and on financial values obtained from the financial database, with respect to the customers, the employees and the stockholders, and calculates the principal components as a customer loyalty indicator, an employee loyalty indicator and a stockholder loyalty indicator;
calculates a customer score, an employee score and a stockholder score by multiplying the premium indicator, the recognition indicator and the loyalty indicator for each of a customer category, an employee category and a stockholder category; and
calculates a comprehensive indicator as a corporate brand score by weighting the customer score, the employee score and the stockholder score.

2. A corporate value evaluation model, comprising:
a corporate image survey database storing corporate image survey data obtained from customers, employees and stockholders;
a financial database storing company's financial data; and
a corporate brand calculation processing server, wherein
the corporate brand calculation processing server:
calculates return on sales obtained mainly from the financial database, which serves as a customer premium indicator;
calculates employee's productivity (calculated as operating profits/(personnel costs, welfare facility's costs, etc.)) obtained mainly from the financial database, which serves as an employee premium indicator;
calculates a price-book value ratio obtained mainly from the financial database, which serves as a stockholder premium indicator;
calculates a level of favorable impression obtained from the corporate image survey database, which serves as a customer recognition indicator;
calculates an employment/working volition obtained from the corporate image survey database, which serves as an employee recognition indicator;
calculates an intention to purchase stock obtained from the corporate image survey database, which serves as a stockholder recognition indicator;
performs principal component analysis on evaluated scores obtained from the corporate image survey database and on financial values obtained from the financial database, with respect to the customers, the employees and the stockholders, and calculates the principal components as a customer loyalty indicator, an employee loyalty indicator and a stockholder loyalty indicator;
calculates a customer score, an employee score and a stockholder score by multiplying the premium indicator, the recognition indicator and the loyalty indicator for each of a customer category, an employee category and a stockholder category;
calculates a comprehensive indicator as a corporate brand score by weighting the customer score, the employee score and the stockholder score; and
shows the value of a corporate brand as a monetary value by using the calculated corporate brand score.

3. A corporate value calculation method, which uses a brand value evaluation system, the system comprising:
a corporate image survey database storing corporate image survey data obtained from customers, employees and stockholders;
a financial database storing company's financial data; and
a corporate brand calculation processing server,
the method comprising, with the corporate brand calculations processing server:
calculating return on sales obtained mainly from the financial database, which serves as a customer premium indicator;
calculating employee's productivity (calculated as operating profits/(personnel costs, welfare facility's costs, etc.)) obtained mainly from the financial database, which serves as an employee premium indicator;
calculating a price-book value ratio obtained mainly from the financial database, which serves as a stockholder premium indicator;
calculating a level of favorable impression obtained from the corporate image survey database, which serves as a customer recognition indicator;
calculating an employment intention obtained from the corporate image survey database, which serves as an employee recognition indicator;
calculating an intention to purchase stock obtained from the corporate image survey database, which serves as a stockholder recognition indicator;
performing principal component analysis on evaluated scores obtained from the corporate image survey database and on financial values obtained from the financial database, with respect to the customers, the employees and the stockholders, and calculating the principal components as a customer loyalty indicator, an employee loyalty indicator and a stockholder loyalty indicator;
calculating a customer score, an employee score and a stockholder score by multiplying the premium indicator, the recognition indicator and the loyalty indicator for each of a customer category, an employee category and a stockholder category; and
calculating a comprehensive indicator as a corporate brand score by weighting the customer score, the employee score and the stockholder score.

4. A brand value evaluation method, which uses a brand value evaluation system, the system comprising:
a corporate image survey database storing corporate image survey data obtained from customers, employees and stockholders;
a financial database storing company's financial data; and
a corporate brand calculation processing server, the method comprising, with the corporate brand calculation processing server:
calculating return on sales obtained mainly from the financial database, which serves as a customer premium indicator;
calculating employee's productivity (calculated as operating profits/(personnel costs, welfare facility's costs, etc.)) obtained mainly from the financial database, which serves as an employee premium indicator;
calculating a price-book value ratio obtained mainly from the financial database, which serves as a stockholder premium indicator;
calculating a level of favorable impression obtained from the corporate image survey database, which serves as a customer recognition indicator;
calculating an employment intention obtained from the corporate image survey database, which serves as an employee recognition indicator;
calculating an intention to purchase stock obtained from the corporate image survey database, which serves as a stockholder recognition indicator;
performing principal component analysis on evaluated scores obtained from the corporate image survey database and on financial values obtained from the financial database, with respect to the customers, the employees and the stockholders, and calculating the principal components as a customer loyalty indicator, an employee loyalty indicator and a stockholder loyalty indicator;
calculating a customer score, an employee score and a stockholder score by multiplying the premium indicator, the recognition indicator and the loyalty indicator for each of a customer category, an employee category and a stockholder category;
calculating a comprehensive indicator as a corporate brand score by weighting the customer score, the employee score and the stockholder score; and
showing the value of a corporate brand as a monetary value by using the calculated corporate brand score.
